(19) United States
(12) Patent Application Publication
(10) Pub. No.: US 2003/0222115 A1
(43) Pub. Date: Dec. 4, 2003

(54) Carpenter's U-shape stapler troubleshooting mechanism

(76) Inventor: Tung I. Chen, Taipei (TW)

Correspondence Address: CHEN Tung I, PO Box 82-144, Taipei, TW

(21) Appl. No.: 10/159,036

(22) Filed: Jun. 3, 2002

(51) Int. Cl. B25C 5/02

(52) U.S. Cl. 227/127

(57) ABSTRACT

A trouble shooting mechanism to fast remove jammed staples in a carpenter's stapler to promote easy operation and economic benefits of the stapler by providing a retractable receiver cover at the striking unit, wherein U-shape stapler may be inserted or removed as desired and the end cover may be forthwith removed for troubleshooting in case of jammed staples without having to remove the staple drive unit.

### BACKGROUND OF THE INVENTION

(a) Field of the Invention

The present invention is related to a carpenter's stapler trouble shooting mechanism, and more particularly, to one that can rapidly remove jammed staples.

(b) Description of the Prior Art

A stapler by allowing continuous binding to improve speed and efficiency in fixing boards or panels is a carpenter's tool frequently used in decoration works. Most of the staplers available in the market have a built-in tract accommodate staples, a drive unit to push forward staples and a trigger unit to fire staples one by one. The stapler known for fast and efficient in delivering the staples is a very important tool for a carpenter. However, as the staple is fired by high elasticity to directly enter into a board or panel, the diameter of general staple is limited and the stapler while in use must be held against the board or panel. Therefore, the biggest problem is that the staple could get easily stuck in the outlet of the striking unit as it fails to bear the instantaneous elasticity, thus to prevent continuous use of the stapler.

Naturally, any stuck staple must be removed. To do that, one has to remove the driver unit provided in the rear part of the stapler, empty the tract to remove the jammed staple before reloading the staples and restoring the drive unit into the stapler. Such removal of jammed staples is difficult, interrupting the work, and compromising the convenience and economy of the stapler in general.

### SUMMARY OF THE INVENTION

The present invention is related to a carpenter's stapler trouble shooting mechanism, and more particularly, to one that can rapidly remove jammed staples.

It is the primary object of the present invention to provide a carpenter's U-shape stapler troubleshooting mechanism essentially comprised of a striking unit provided at the front of the stapler containing a plurality of staples; a striking plate provided to the striking unit, and a hole to horizontally eject the staple formed in the center of the striking unit characterized by that: an end cover being provided on the striking unit; the end cover being permitted for longitudinal movement up and down in relation to the striking unit; two flanges relatively to each other extending from a face panel of the face cover; two corresponding troughs being formed between two flanges of the end cover; two resilient plunges being each provided on the striking unit in relation to both sides of the surface of the end cover to hold against the end cover.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a sectional view of the preferred embodiment of the present invention.

FIG. 3 is a schematic view showing a troubleshooting performed by the preferred embodiment of the present invention.

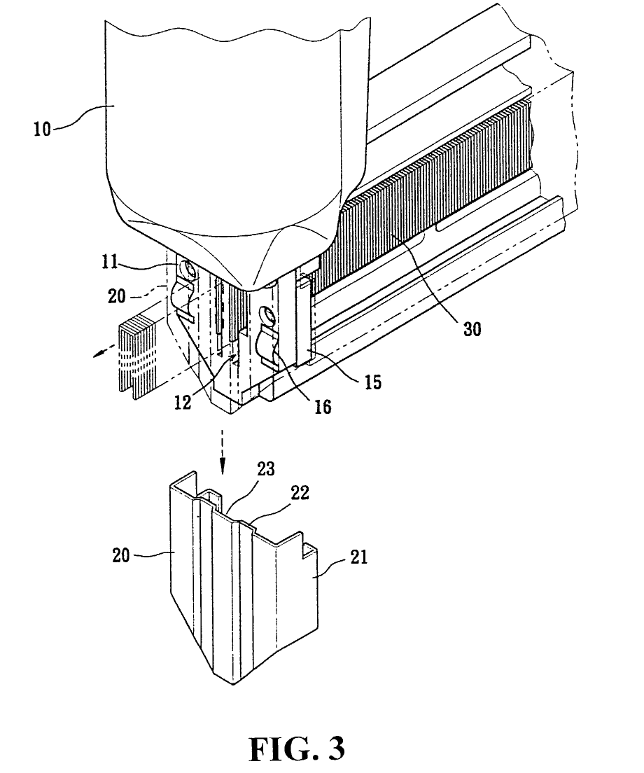

FIG. 4 is a perspective view of another preferred embodiment of the present invention.

FIG. 5 is a sectional view of another preferred embodiment of the present invention.

FIG. 6 is a schematic view showing a troubleshooting performed by another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

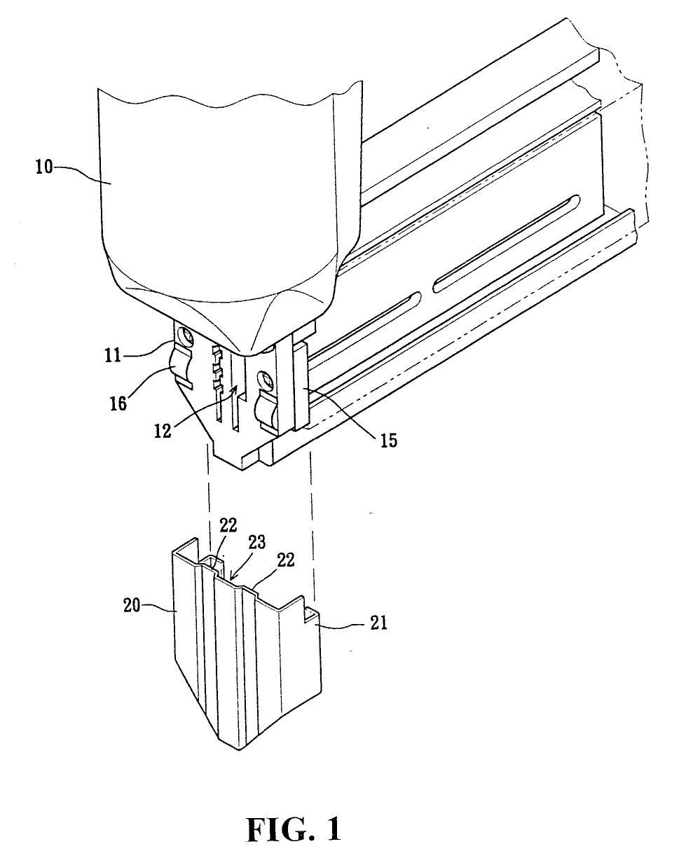

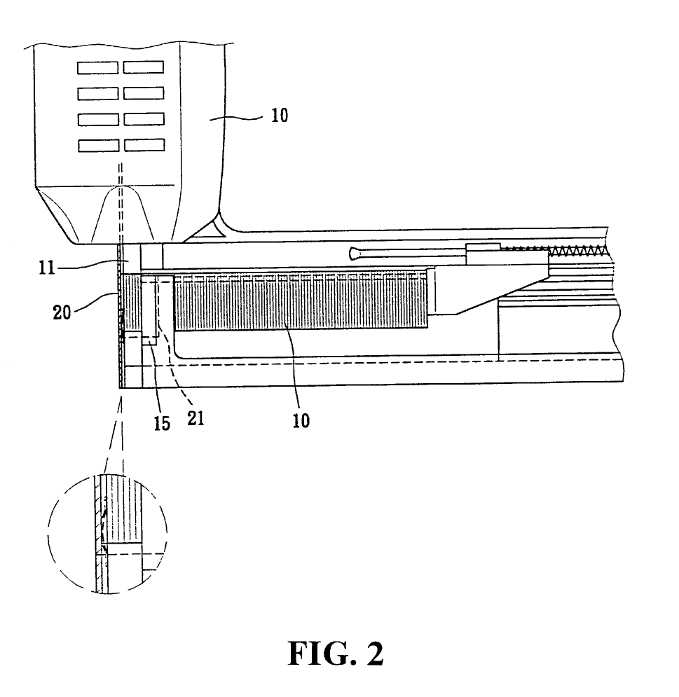

Referring to FIGS. 1 and 2, a striking unit 11 is provided at the front end of a body 10 accommodating multiple staplers 30. ...........................An end cover 20 is latched to the striking unit 11 and held by a resilient plunger 16 to prevent the end cover 20 from accidental falling off in the course of work for easy troubleshooting.

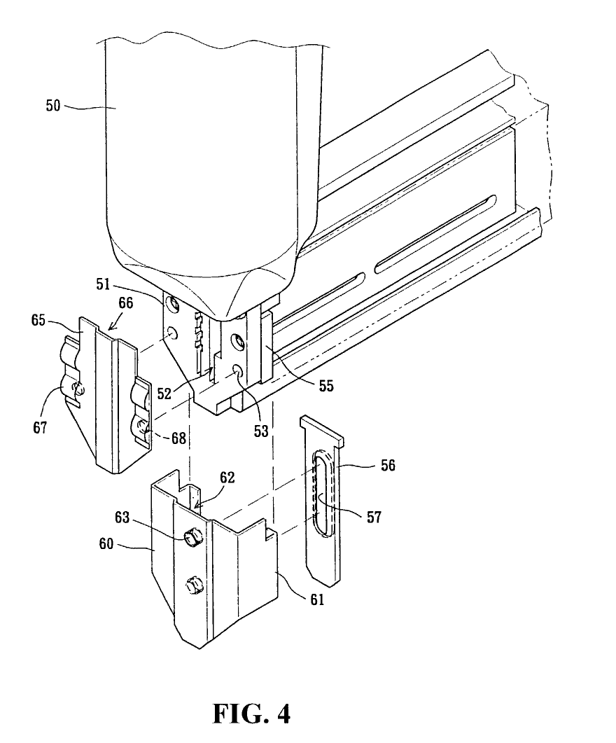

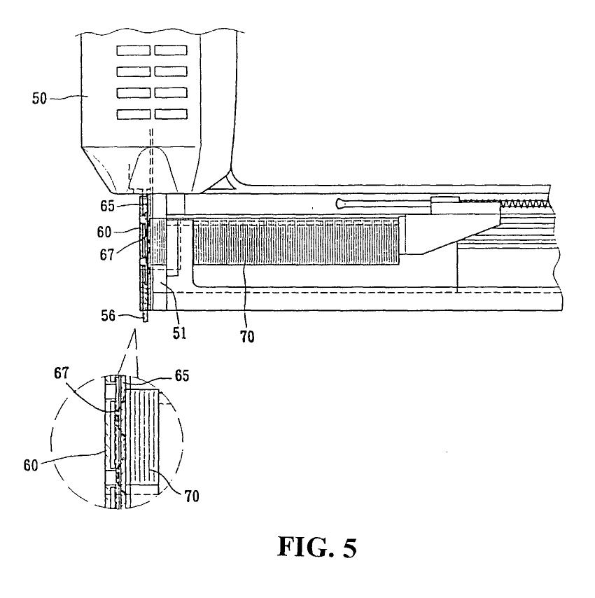

As illustrated in FIGS. 4 and 5, in another preferred embodiment of the present invention, a safety push 56 is provided to the striking unit 51 and a restriction hole 53 is each provided on both sides of a staple ejection hole 52 in the striking unit 51 to secure a positioning plate 65. Two tracks 55 respectively provided on both sides of the striking unit 51 is inserted with an end cover in shape corresponding to that of the striking unit 51. Two L-shape latches 61 are respectively provided on both sides of the end cover 60 in relation to both of tracks 55, and a slide channel 62 protruding outwardly is formed on the end cover 60 in relation to the safety push 56. Two rivet heads 63 are formed on the slide channel 62 to respectively latch in a hole 57 provided to the safety push 57 for the safety push 57 to slide in relation to the end cover.

The positioning plate 65 is provided between the striking unit 51 and the end cover 60, and a staple trough 66 is formed in the positioning plate 65 in relation to the staple ejection hole 52 in the striking unit. Two restriction pillars 68 are provided on the surface of the positioning plate 65 at where relatively to the striking unit 51 to be respectively inserted into the restriction hole in the striking unit 51 for the positioning plate 65 to be retained by the striking unit 51. Two resilient plungers 67 are respectively provided on both sides of the positioning plate in relation to the end cover 60 so to secure the end cover 60 to the string unit 51 to constitute a mechanism that allows fast remove of any jammed staples 70.

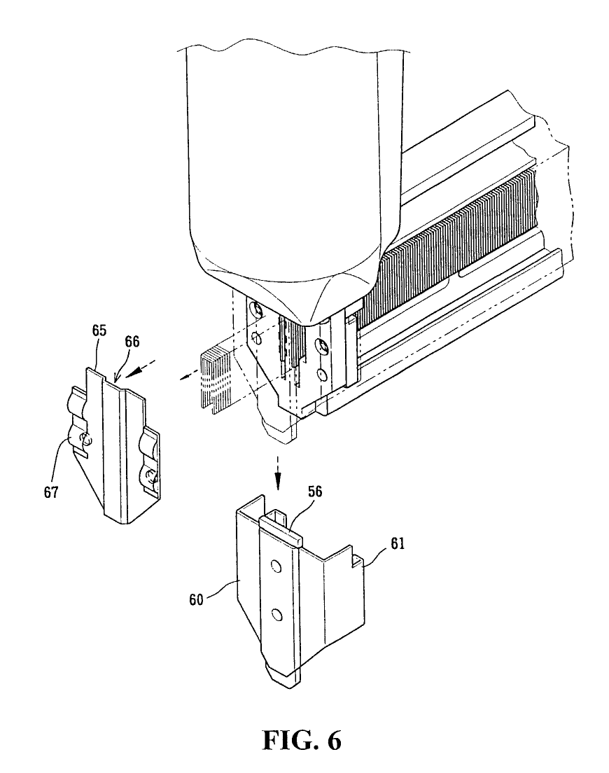

When any section of staples 70 is jammed as illustrated in FIGS. 5 and 6, the user simply slides the end cover 60 downward to disengage it from the striking unit 51, then withdraw the positioning plate 65 out of the striking unit 51 to expose the staple ejection hole 52 in the striking unit 51, thus to fast remove the jammed staples 70. When the jammed staples 70 are removed, the positioning plate is inserted into the striking unit 51, and the end cover 60 is slide upward to latch the striking unit 51 while the resilient plungers of the positioning plate 65 hold against the end cover 60 to prevent it from accidental fall off in the course of work. Therefore, removal of jammed staples is done without requiring to disassembly the rear of the carpenter's stapler.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A carpenter's U-shape stapler troubleshooting mechanism essentially comprised of a striking unit provided at the front of the stapler containing a plurality of staples; a striking plate provided to the striking unit, and a hole to horizontally eject the staple formed in the center of the striking unit characterized by that: an end cover being provided on the striking unit; the end cover being permitted for longitudinal movement up and down in relation to the striking unit; two flanges relatively to each other extending from a face panel of the face cover; two corresponding troughs being formed between two flanges of the end cover; two resilient plunges being each provided on the striking unit in relation to both sides of the surface of the end cover to hold against the end cover.

2. A carpenter's U-shape stapler troubleshooting mechanism as claimed in claim 1, wherein, two tracks being respectively provided on both sides of the striking unit; both side of the end cover being provided corresponding L-shape latches; and the end cover being permitted only to slide up or down in relation to the striking unit without moving back or forth.

3. A carpenter's U-shape stapler troubleshooting mechanism essentially comprised of a staking unit provided at the front of the stapler containing a plurality of staples; a striking plate provided to the striking unit, a hole to horizontally eject the staple formed in the center of the striking unit and a safety push being provided to the striking unit characterized by that: an end cover being provided on the striking unit; the end cover being permitted for longitudinal movement up and down in relation to the striking unit; an erected trough being provided on the surface of the end cover; the safety push being provided in the erected trough; a positioning plate being inserted into the striking unit; a staple trough in relation to the staple ejection hole being formed in the positioning plate; two resilient plunges being each provided on the positioning plate in relation to both sides of the surface of the end cover to hold against the end cover.

4. A carpenter's U-shape stapler troubleshooting mechanism as claimed in claim 3, wherein, two tracks are respectively formed on both sides of the striking unit; two L-shape latches in relation to those two tracks are provided on both sides of the end cover to allow the end cover to slide up or down only without moving back or forth.

5. A carpenter's U-shape stapler troubleshooting mechanism as claimed in claim 3, wherein, two restriction holes are respectively provided on both sides of the staple ejection hole; and both sides of the positioning plate are formed with restriction pillars in relation to those two restriction holes to permit easy insertion of the positioning plate into the striking unit.

6. A carpenter's U-shape stapler troubleshooting mechanism as claimed in claim 3, wherein, a rivet head is formed in the slide trough of the end cover and a slide hole is provided in the safety push in relation to the rivet head to permit the safety push to slide on the end cover.
